(19) United States
(12) Patent Application Publication
(10) Pub. No.: US 2023/0374353 A1
(43) Pub. Date: Nov. 23, 2023

(54) COMPOSITE PRESSURE SENSITIVE ADHESIVES

(71) Applicant: 3M INNOVATIVE PROPERTIES COMPANY, St. Paul, MN (US)

(72) Inventors: Michael J. Maher, St. Paul, MN (US); Adam O. Moughton, Minneapolis, MN (US); Jonathan E Janoski, Woodbury, MN (US); Anthony F . Schultz, Forest Lake, MN (US); Clinton G. Wiener, St. Paul, MN (US)

(21) Appl. No.: 18/247,276

(22) PCT Filed: Sep. 13, 2021
(86) PCT No.: PCT/IB2021/058318

§ 371 Date: Mar. 30, 2023

Related U.S. Application Data
(60) Provisional application No. 63/090,843, filed on Oct. 13, 2020.

(51) Int. Cl. C09J 133/08; C09J 11/08

(52) U.S. Cl. CPC C09J 133/08; C09J 11/08

(57) ABSTRACT

Described herein is a pressure sensitive adhesive composite composition. The composition comprises: a plurality of polymeric microspheres dispersed within a (meth)acrylate-based matrix, wherein the polymeric microspheres are derived from 20-100 wt % of isobornyl (meth)acrylate; and the (meth)acrylate-based matrix comprises an at least partially polymerized reaction product comprising a C₄ to C₂₀ (meth)acrylate ester monomer. In some embodiment, these composite pressure sensitive adhesives show good peel adhesion to low surface energy substrates. In some embodiment, these composite pressure sensitive adhesives are optically clear.

### TECHNICAL FIELD

This disclosure relates to a pressure sensitive adhesive comprising a (meth)acrylate-based matrix with a plurality of polymeric microspheres dispersed therein. Such adhesives can have good bonding to both low and high energy substrates and/or are optically clear.

### SUMMARY

Acrylate pressure sensitive adhesives are well-known in the art. Ulrich (U.S. Pat. No. RE 24,906) describes alkyl acrylate copolymers, which comprise a major amount of C4 to C14 alkyl esters of acrylic acid monomers and a minor portion of a copolymerizable polar monomer such as acrylic acid. Such adhesives are widely popular due to their availability, their low cost, and their ability to provide the requisite fourfold balance of adhesion, cohesion, stretchiness, and elasticity known to be required for effective pressure sensitive adhesives.

In some industries, such as automotive, display and graphics or aerospace, manufacturers have started to use low surface energy materials. Advances in polyolefin chemistries are leading to materials that are easy to process, easy to color, possess good stiffness and most importantly are low cost. This combination of good mechanical performance at a cost of about half that of typical engineering thermoplastics is enabling polyolefins to advance rapidly in the globally competitive and cost conscience marketplace. While the market is moving towards different, lower cost materials, the need to assemble and bond these materials still remains. The substrates needing to be bonded are changing from traditional materials like metal, paint and wood to plastics such as polypropylene or polyethylene. In some instances, the traditional materials are bonded to plastics and there is a need for a pressure sensitive adhesive that has adequate bonding to both a high energy surface and a low energy surface. In some applications, the substrates may be transparent materials and thus, a pressure sensitive adhesive that can bond to the substrate while also being optically clear is necessary.

In one aspect, a pressure sensitive adhesive composition is disclosed. The composition comprises: a plurality of polymeric microspheres dispersed within (meth)acrylate-based matrix, wherein the polymeric microspheres are derived from 20-100 wt % of isobomyl (meth)acrylate; and the (meth)acrylate-based matrix comprises an at least partially polymerized reaction product comprising a C₄ to C₂₀ (meth)acrylate ester monomer.

In another aspect, a method of making an article is described comprising:
(a) providing a mixture comprising: a C₄ to C₂₀ (meth)acrylate ester monomer;
(b) dispersing a plurality of polymeric microspheres in the mixture to form a dispersion, wherein the polymeric microspheres are derived from 20-100 wt % of isobomyl acrylate; and
(c) curing the dispersion.

The above summary is not intended to describe each embodiment. The details of one or more embodiments of the invention are also set forth in the description below. Other features, objects, and advantages will be apparent from the description and from the claims.

### DESCRIPTION OF THE FIGURES

Embodiments of the present disclosure are illustrated by way of example, in the accompanying drawings, which are for illustrative purposes only and not drawn to scale.

FIG. 1 is a schematic cross-sectional view of a multi-layered adhesive article comprising a composite adhesive layer according to one embodiment of the present disclosure; and

FIG. 2 is a schematic cross-sectional view of a composite adhesive layer according to one embodiment of the present disclosure.

### DETAILED DESCRIPTION

As used herein, the term
“a”, “an”, and “the” are used interchangeably and mean one or more; and
“and/or” is used to indicate one or both stated cases may occur, for example A and/or B includes, (A and B) and (A or B);
“cross-linking” refers to connecting two pre-formed polymer chains using chemical bonds or chemical groups in order to increase the modulus of the material;
“interpolymerized” refers to monomers that are polymerized together to form a polymer backbone; and
“(meth)acrylate” refers to compounds containing either an acrylate (CH₂═CHCOOR) or a methacrylate (CH₂═CCH₃COOR) structure or combinations thereof.

Also herein, recitation of ranges by endpoints includes all numbers subsumed within that range (e.g., 1 to 10 includes 1, 2 ,3 ,4 ,5, 6, 7, 8, 9, and 10).

Also herein, recitation of “at least” followed by a number include the recited number and all numbers greater (for example, “at least one” includes at least 2, at least 4, at least 6, at least 8, at least 10, at least 25, at least 50, at least 100, etc.).

The pressure sensitive adhesives of the present disclosure are a composite comprising a plurality of polymeric microspheres dispersed in a (meth)acrylate-based matrix.

### Polymeric Microspheres

The polymeric microspheres of the present disclosure are isobomyl (meth)acrylate-based. In one embodiment, the polymeric microspheres are derived from at least 20, 25, 30, 40, 50, 55, 60, 65, 70, or even 75 wt % of isobornyl (meth)acrylate monomer. In one embodiment, the polymeric microspheres are derived from at most 70, 75, 80, 85, 90, 95, 99, 99.5, or even 100 wt % of isobornyl (meth)acrylate monomer. The amount of isobomyl (meth)acrylate used can be adjusted based on the application.

When the polymeric microsphere is a copolymer, typically, other (meth)acrylate-based comonomers are combined with the isobomyl (meth)acrylate monomer. The (meth)acrylate-based comonomers should have a glass transition temperature above room temperature, for example, at least 23, 25, 30, 40, or even 50° C.; and at most 100, 125, or even 150° C. Such comonomers include alkyl(meth)acrylates comprising at least 1, 2, 4, 6, 8, 10, 12, or even 14 carbon atoms; and at most 16, 18, 20, 25, or even 30 carbon atoms. Exemplary comonomers used to derive the polymeric microspheres include, but are not limited to methyl (meth)acrylate, ethyl (meth)acrylate, n-propyl (meth)acrylate, isopropyl (meth)acrylate, n-butyl (meth)acrylate, sec-butyl (meth)acrylate, tert-butyl (meth)acrylate, cyclohexyl (meth)acrylate, 2-dodecyl (meth)acrylate, stearyl (meth)acrylate, phenyl (meth)acrylate, benzyl (meth)acrylate, 3,3,5 trimethylcyclohexyl (meth)acrylate, 2-phenoxyethyl (meth)acrylate, and mixtures thereof.

The polymeric microspheres may be made using techniques known in the art. In one embodiment, the polymeric microspheres can be made via suspension polymerization of a reaction mixture comprising isobomyl (meth)acrylate, optional comonomers, and a stabilizer. In some embodiments, a suspension of monomers is formed, and polymerization is carried out using thermal initiation. The suspension is a water-in-oil or an oil-in-water suspension. In some such embodiments, the suspension is an oil-in-water suspension, wherein the monomers are stabilized in a bulk water phase by employing one or more stabilizers. Stabilizers useful in embodiments of the present disclosure can include, for example, inorganic stabilizers, surfactants, polymer additives, and combinations thereof.

In some embodiments, the stabilizer may be an inorganic stabilizer such as those used in Pickering emulsion polymerizations (e.g., colloidal silica).

In some embodiments, the stabilizer may be a polymer additive. Polymer additives useful in embodiments of the present disclosure may include, for example, polyacrylamide, polyvinyl alcohol, partially acetylated polyvinyl alcohol, hydroxyethyl cellulose, N-vinyl pyrrolidone, carboxymethyl cellulose, gum arabic, and mixtures thereof. In some embodiments, the polymer additive includes those sold under the trade designation “SUPERFLOC” (e.g., “SUPERFLOC N-300”) by Kemira Oyj, Helsinki, Finland.

In some embodiments, the stabilizer may be a surfactant. In some embodiments, the surfactant may be anionic, cationic, zwitterionic, or nonionic in nature and the structure thereof not otherwise particularly limited. In some embodiments, the surfactant is also a monomer and becomes incorporated within the polymer microsphere molecules. In other embodiments, the surfactant is present in the polymerization reaction vessel, but is not incorporated into the polymer microsphere as a result of the polymerization reaction.

Non-limiting examples of anionic surfactants useful in embodiments of the present disclosure include sulfonates, sulfolipids, phospholipids, stearates, laurates and sulfates. Sulfates useful in embodiments of the present disclosure include sulfates sold under the trade designation “STEPANOL” by the Stepan Company, Northfield IL, and “HITENOL” by the Montello, Inc., Tulsa, OK, and mixtures thereof.

Non-limiting examples of nonionic surfactants useful in embodiments of the present disclosure include block copolymers of ethylene oxide and propylene oxide, such as those sold under the trade designations “PLURONIC”, “KOLLIPHOR”, or “TETRONIC”, by the BASF Corporation of Charlotte, NC; ethoxylates formed by the reaction of ethylene oxide with a fatty alcohol, nonylphenol, dodecyl alcohol, and the like, including those sold under the trade designation “TRITON”, by the Dow Chemical Company of Midland, MI; oleyl alcohol; sorbitan esters; alkylpolyglycosides such as decyl glucoside; sorbitan tristearate; and combinations of one or more thereof.

Non-limiting examples of cationic surfactants useful in embodiments of the present disclosure include cocoalkylmethyl[polyoxyethylene (15)] ammonium chloride, benzalkonium chloride, cetrimonium bromide, demethyldioctadecylammonium chloride, lauryl methyl gluceth-10 hydroxypropyl diammonium chloride, tetramethylammonium hydroxide, monoalkyltrimethylammonium chlorides, monoalkyldimethylbenzylammonium chlorides, dialkylethylmethylammonium ethosulfates, trialkylmethylammonium chlorides, polyoxyethylenemonoalkylmethylammonium chlorides, and diquaternaryammonium chlorides; the ammonium functional surfactants sold by Akzo Nobel N.V. of Amsterdam, the Netherlands, under the trade designations “ETHOQUAD”, “ARQUAD”, and “DUOQUAD”; and mixtures thereof.

In some embodiments, where a stabilizer is employed in an oil-in-water suspension polymerization reaction, it is employed in an amount of at least 0.01, 0.05, 0.1, 0.5, or even 1.0 wt %, based on the total weight of solids in the aqueous polymerizable reaction mixture. In some embodiments where a stabilizer is employed in an oil-in-water suspension polymerization reaction, it is employed in an amount of up to 4.0 or even 5.0 wt. %, based on the total weight of solids in the aqueous polymerizable pre-adhesive reaction mixture.

In some embodiments, a crosslinking agent may be used in the microsphere reaction mixture to modify the properties of the resultant microspheres. Nonlimiting examples of suitable crosslinking agents include multifunctional (meth)acrylate(s), e.g., butanediol diacrylate or hexanediol diacrylate, hexanediol diacrylate or other multifunctional crosslinkers such as divinylbenzene and mixtures thereof. In some embodiments, 0.005, 0.01, 0.02, 0.05, or even 0.08 wt % of the crosslinker is used based on the total weight of monomers used in the polymerization of the polymeric microspheres. In some embodiments, 0.1, 0.2, 0.5, 1, 2, or even 5 wt % of the crosslinker is used based on the total weight of monomers used in the polymerization of the polymeric microspheres.

In some embodiments, an initiator is used that will generate crosslinking in situ by abstracting hydrogens from the polymer in the microspheres allowing crosslinking. Such initiators can include: some peroxide initiators such as benzoyl peroxide and/or azo initiators. Typically, these crosslinking initiators are used in concentrations similar to the crosslinking agent described above (e.g., 0.005 to 5 wt %).

The polymerization of the aqueous polymerizable reaction mixture may be carried out using conventional suspension polymerization techniques familiar to those of ordinary skill in the relevant arts.

In some embodiments where thermal decomposition is employed to initiate polymerization, suspension polymerization of the monomers employed to make the polymer microspheres of the present disclosure may be carried out by blending the stabilizer(s) with water to provide an aqueous phase and blending the monomer composition and a thermal initiator to provide an oil phase. The aqueous phase and the oil phase may then be combined and stirred vigorously enough to form a suspension. The suspension may generally be formed, for example, by stirring the combined aqueous and oil phases with a 3-blade or 4-blade stirrer at a speed of 500 to 1500 (e.g. 1000) revolutions per minute (“rpm”). The suspension may then be heated to a temperature wherein decomposition of the initiator occurs at a rate suitable to sustain a suitable rate of polymerization (e.g., 60° C.).

Non-limiting examples of suitable thermal initiators include organic peroxides or azo compounds conventionally employed by those skilled in the art of thermal initiation of polymerization, such a dicumyl peroxide, benzoyl peroxide, or 2,2′-azo-bis(isobutyronitrile) (“AIBN”) and thermal initiators sold under the trade designation “VAZO” by Chemours Canada Company, ON, Canada. Though in the case of suspension polymerization water-soluble initiators are often preferred, in some embodiments an oil-soluble initiator (e.g., 2-2′-azobis(2,4-dimethylvaleronitrile)) is preferred. The amount of initiator is typically in a range of 0.05 to 2 wt. % or in a range of 0.05 to 1 wt. %, or in a range of 0.05 to 0.5 wt % based on the total weight of monomers used to prepare the polymeric microspheres.

In some embodiments, water is present in the polymerizable reaction mixture, for example, in an amount of at least 35, 40, 45, or even at least 50 wt. %. In some embodiments, water is present in the polymerizable reaction mixture, for example, in an amount of up to 90, 80, 70, or even 60 wt. %.

In general, conditions of suspension polymerization and methodology employed are the same or similar to those employed in conventional suspension polymerization methods. In some embodiments, the oil-in-water suspension polymerization is carried out using thermal initiation. In such embodiments, one useful polymerization initiator is 2-2′-azobis(2,4-dimethylvaleronitrile), which is a water-insoluble initiator (obtained from Chemours Canada Company, ON, Canada). In some such embodiments, the temperature of the suspension is adjusted prior to and during the polymerization is 30° C. to 100 C, or 40 C to 80 C, or 40 C to 70 C, or to 45° C. to 65° C. In some embodiments, the peak temperature during the exotherm may reach as high as 75, 90, or even 110° C.

Agitation of the suspension at elevated temperature is carried out for a suitable amount of time to decompose substantially all of the thermal initiator and react substantially all of the monomers added to the suspension to form a polymerized suspension. In some embodiments, elevated temperature is maintained for a period of 1 hour to 48 hours, 2 hours to 24 hours, or 4 hours to 18 hours, or 8 hours to 16 hours.

During polymerization, it may be necessary in some embodiments to add additional thermal initiator to complete the reaction of substantially all of the monomer content added to the reaction vessel to prepare the microspheres. It will be appreciated that completion of the polymerization is achieved by careful adjustment of conditions, and standard analytical techniques, such as gas chromatographic analysis of residual monomer content, will inform the skilled artisan regarding the completion of polymerization of the polymeric microspheres.

In other embodiments, the polymerization of the microspheres may occur in an aqueous mixture that may also include an organic solvent. Examples of suitable organic solvents and solvent mixtures include, in various embodiments, one or more of ethanol, methanol, toluene, methyl ethyl ketone, ethyl acetate, isopropyl alcohol, tetrahydrofuran, 1-methyl-2-pyrrolidinone, 2-butanone, acetonitrile, dimethylformamide, dimethyl sulfoxide, dimethylacetamide, dichloromethane, t-butanol, methyl isobutyl ketone, methyl t-butyl ether, and ethylene glycol. If used, no more than 10 wt % organic solvent is used in the microsphere reaction mixture.

Following polymerization, the thus obtained polymeric microspheres can be collected using conventional means such as filtering, optionally washed, and dried.

The particles of the present disclosure are typically spherical-shaped particles. In preferred embodiments, polymeric microspheres of the present disclosure have an average particle diameter of at least 1, 5, 10, 20, 30, 40, or even 50 micrometers (μm). In some embodiments, the polymeric microspheres of have an average particle size at most 60, 80, 90, 100, 120, 150, 180, or even 200 μm. The particle size may be measured by conventional means using, for example, a Horiba LA 910 particle size analyzer (Horiba, Ltd, Kyoto, Japan).

Depending on the selection of the monomers used to synthesis the polymeric microspheres, the polymeric microspheres may or may not be tacky (i.e., sticky). Preferably, the polymeric microspheres are non-tacky and behave as a powder, whereas the tacky polymeric microspheres tend to stick together more. Generally, the more isobornyl (meth)acrylate present, the less tacky the polymeric microsphere. Because isobornyl (meth)acrylate has a Tg above room temperature, and preferably the optional comonomer also have a Tg above room temperature, the polymeric microspheres of the present disclosure are comprised of a amorphous polymer. In one embodiment, the polymeric microspheres disclosed herein have a glass transition temperature, Tg, of at least −60, −50, −40, −30, −20, −10, −5, 0, 5, 10, 15, 20, 25, or even 30° C. In one embodiment, the polymeric microspheres disclosed herein have a glass transition temperature, Tg, of at most 10, 15, 20, 30, 50, 70, 100, 125, or even 150° C.

In the present disclosure, the plurality of microspheres are dispersed in a (meth)acrylate-based matrix to form a composite adhesive.

### (Meth)acrylate-Based Matrix

The matrix of the pressure sensitive adhesive of the present disclosure is (meth)acrylate-based and comprises at least 50% by weight (relative to the other monomers) of a polymerized (meth)acrylate ester monomer.

The (meth) acrylate-based matrix is a polymerized reaction prepared from at least a (meth)acrylate ester monomer.

Useful (meth)acrylic esters include at least one monomer selected from the group consisting of a monofunctional (meth)acrylate ester of a linear, branched, and/or cyclic non-tertiary alkyl alcohol, the alkyl group of which comprises at least 4, 5, 6, 7, 8 or even 10 carbon atoms; and at most 14, 16, 18 or even 20 carbon atoms. In one embodiment, the (meth)acrylate ester monomer comprises 4 to 20 carbon atoms.

Exemplary (meth)acrylate ester monomers include, methyl (meth)acrylate, ethyl (meth)acrylate, n-propyl (meth)acrylate, isopropyl (meth)acrylate, n-butyl acrylate, isobutyl acrylate, tert-butyl (meth)acrylate, 2-ethylhexyl acrylate, n-pentyl (meth)acrylate, iso-pentyl (meth)acrylate, n-hexyl (meth)acrylate, iso-hexyl (meth)acrylate, cyclohexyl (meth)acrylate, phenyl (meth)acrylate, n-octyl (meth)acrylate, iso-octyl (meth)acrylate, 2-octyl(meth)acrylate, 2-ethylhexyl (meth)acrylate, decyl (meth)acrylate, lauryl (meth)acrylate, 2-propylheptyl (meth)acrylate, stearyl (meth)acrylate, isobornyl acrylate, benzyl (meth)acrylate, octadecyl acrylate, nonyl acrylate, dodecyl acrylate, isophoryl (meth)acrylate, dodecyl (meth)acrylate, and any combinations or mixtures thereof.

In one embodiment, the (meth)acrylate ester monomers are copolymerized with polar copolymerizable monomers. The polar copolymerizable monomers can be acid or non-acid functional polar monomers such as acrylic acid, hydroxyethyl acrylate, N-methyl acrylamide, or any monomer having a sidechain containing at least one of the following: alcohol, carboxylic acid, amine, amide, imide, thiol, ester, phosphate, and combinations thereof. Exemplary polar monomers include: acrylic acid, methacrylic acid, itaconic acid, fumaric acid, crotonic acid, citraconic acid, and maleic acid, hydroxyalkyl acrylates, acrylamides and substituted acrylamides (such as N,N-dialkylaminoalkyl (meth)acrylates), acrylamines and substituted acrylamines, lactames and substituted lactames, □-carboxyethylacrylate, N-vinyl-2-pyrrolidone, N-vinyl caprolactam, acrylonitrile, and any combinations or mixtures thereof.

When copolymerized with strongly polar monomers, the (meth)acrylate ester monomer generally comprises at least about 75 wt % of the polymerizable monomer composition. When copolymerized with moderately polar monomers, the (meth)acrylate ester monomer generally comprises at least about 50 wt % of the polymerizable monomer composition. Strongly polar monomers include monoolefinic mono- and dicarboxylic acids, hydroxy alkyl acrylate, cyanoalkyl acrylates, acryalmides or substituted acrylamides, or from moderately polar monomers such as N-vinyl pyrrolidone, acrylonitrile, vinyl chloride or diallyl phthalate. The strongly polar monomer preferably comprises up to about 25 wt %, more preferably up to about 15 wt %, of the polymerizable monomer composition. The moderately polar monomer preferably comprises up to about 30 wt %, more preferably from about 5 wt % to about 30 wt % of the polymerizable monomer composition.

Additional monomers may be added to the composition to alter the performance of the matrix in the pressure sensitive adhesive, such as a non-polar monomer. The non-polar monomer may be a non-polar ethylenically unsaturated monomer selected from monomers comprising a hydrocarbon sidechain Examples of suitable non-polar comonomers include 3,3,5-trimethylcyclohexyl acrylate, cyclohexyl acrylate, n-octyl acrylamide, t-butyl acrylate, methyl methacrylate, ethyl methacrylate, and combinations thereof

A cross-linking agent is used to create a three-dimensional polymer network and to achieve high internal strength of the (meth)acrylate-based matrix within the pressure sensitive adhesive. Useful cross-linking agents include photosensitive crosslinking agents, which are activated by ultraviolet (UV) light. Useful cross-linking agents include: multifunctional (meth)acrylates, triazines, and combinations thereof. Exemplary crosslinking agents include substituted triazines such as 2,4,-bis(trichloromethyl)-6-(4-methoxy phenyl)-s-triazine, 2,4-bis(trichloromethyl)-6-(3,4-dimethoxyphenyl)-s-triazine, and the chromophore-substituted halo-s-triazines disclosed in U.S. Pat. Nos. 4,329,384 and 4,330,590 (Vesley). Other useful crosslinking agents include multifunctional alkyl acrylate monomers such as trimetholpropane triacrylate, pentaerythritol tetra-acrylate, 1,2 ethylene glycol diacrylate, 1,4 butanediol diacrylate, 1,6 hexanediol diacrylate, and 1,12 dodecanol diacrylate. Various other crosslinking agents with different molecular weights between (meth)acrylate functionality may also be useful.

### Composite Adhesive

Described below is more detail on the preparation of the composite adhesive according to the present disclosure.

In the present disclosure, the (methyacrylic ester (such as a C₄ to C₂₀ (meth)acrylatic ester, and and optional comonomer are polymerized to form a (co)polymer for the (meth)acrylate-based matrix.

In one embodiment, the polymer of the matrix comprise at least 50, 60, 70, or even 75% by weight; at most 80, 85, 90, 95, 97, or even 99.5% by weight of a C₄ to C₂₀ (meth)acrylate ester monomer relative to the other monomers. A higher amount of the C₄ to C₂₀ (meth)acrylate ester monomer relative to the other comonomers affords adequate adhesion at low temperatures (e.g., below room temperature) and/or higher debonding rates (e.g., >12 in/min).

Optionally, the polymer of the matrix comprises at least 0.5, 1.0, 2.5, 5, 8, or even 10% by weight; at most 15, 18, 20, 25, 30, 35, 40, 45, or even 50% by weight of a polar monomer relative to the other monomers present in the (meth)acrylate-based matrix.

In one embodiment, a cross-linking agent may be added at a level of at least 0.01, 0.1, 0.5, 1.0, 1.5, or even 2 part solid; at most 3, 4, 5, 6 , 8, or even 10 part solid per 100 parts solid versus the weight of all of the monomers used in the preparation of the (meth)acrylate-based matrix. In another embodiment, an initiator is used that will generate crosslinking in situ by abstracting hydrogens from the polymer in the matrix allowing crosslinking of the (meth)acrylate-based matrix. Typically, a crosslinking initiator is used in concentrations of at least 0.01, 0.1, 0.5, 1.0, 1.5, or even 2 part solid; at most 3, 4, 5, 6 , 8, or even 10 part solid per 100 parts solid versus the weight of all of the monomers used in the preparation of the (meth)acrylate-based matrix.

Aside from the selection of particular combinations of the monomers, and cross-linking agent, the molecular weight of the polymeric composition of the (meth)acrylate-based matrix may play a role in the bonding to low surface energy surfaces. Low molecular weights provide good peel values, but poor cohesion, while high molecular weights provide poor peel values, but good cohesion. Thus, a broader molecular weight distribution may be used to achieve a tacky system (low molecular weight fractions) with a high shear (high molecular weight fractions).

In one embodiment, the polymer in the (meth)acrylate-based matrix has a weight average molecular weight of at least 100,000; 200,000; 300,000; 400,000; 500,000; 750,000; or even 1,000,000,000 grams per mole; at most 2,000,000; 2,250,000; 2,500,000; 2,750,000, or even 3,000,000 grams per mole. The molecular weight of the polymer can be determined by gel permeation chromatography as is known in the art. The polymer typically has a molecular weight dispersity that can be calculated as the weight average molecular weight versus the number average molecular weight of the polymer. The inherent viscosity is related to the molecular weight of the polymer, but also includes other factors, such as concentration of the polymer. In the present disclosure, the inherent viscosity of the polymer may be at least 0.4, 0.45, 0.5, 0.6, 0.7, or even 0.8; at most 0.7, 0.8, 1.0, 1.2, 1.4, 1.6, 1.8 or even 2,3 as measured in ethyl acetate at a concentration of 0.15 grams/deciliter (g/dL).

The molecular weight of the polymer in the (meth)acrylate-based matrix may be controlled using techniques known in the art. For example, during polymerization, a chain transfer agent may be added to the monomers to control the molecular weight. Useful chain transfer agents include, for example, those selected from the group consisting of carbon tetrabromide, alcohols, mercaptans, and mixtures thereof. Exemplary chain transfer agents are isooctylthioglycolate and carbon tetrabromide. At least 0.01, 0.05, 0.1, 0.15, 0.2, 0.3, or even 0.4 parts by weight of a chain transfer agent may be used; at most 0.1, 0.2, 0.3, 0.4, 0.5, or even 0.6 parts by weight of a chain transfer agent may be used based upon 100 parts versus the weight of all of the monomers used in preparation of the (meth)acrylate-based matrix.

The (meth)acrylate-based matrix used in the pressure sensitive adhesive of the present disclosure may be polymerized by techniques known in the art, including, for example, the conventional techniques of solventless polymerization. The polymerization of the monomers “substantially solvent free”, that less than 5%, 2%, 1% or even 0.5% by weight of solvent is used based on the weight of the monomers, and more preferably no additional solvent is added during the polymerization. The term “solvent” refers both to water and to conventional organic solvents used in the industry which are volatilized in the process.

The monomer mixture can be polymerized by various techniques, with photoinitiated bulk polymerization being preferred. An initiator is preferably added to aid in polymerization of the monomers or pre-polymerized syrup. The type of initiator used depends on the polymerization process. In a preferred embodiment, photoinitiators are used to initiate the polymerization. Photoinitiators that are useful for polymerizing the acrylate monomers include benzoin ethers such as benzoin methyl ether or benzoin isopropyl ether, substituted benzoin ethers such as 2-methyl-2-hydroxypropiophenone, aromatic sulfonyl chlorides such as 2-naphthalenesulfonyl chloride, and photoactive oxides such as 1-phenyl-1,2-propanedione-2-(o-ethoxycarbonyl)oxime. An example of a commercially available photoinitiator is “IRGACURE 651” available from Ciba, having a formula of 2,2-dimethoxy-1,2-diphenylethane-1-one. Generally, the photoinitiator is present in an amount of about 0.005 to 1 weight percent based on the weight of the monomers. In another embodiment, a thermal initiator may be used, such as for example, AIBN (azobisisobutyronitrile) and/or peroxides. The polymerization may be carried out in the presence of at least one free-radical initiator. Useful free-radical UV initiators include, for example, benzophenones.

In a preferred practice of the disclosure, the polymeric microspheres are blended with the acrylate monomers or an acrylic syrup (which becomes the (meth)acrylate-based matrix). As used herein a syrup refers to a mixture that has been thickened to a coatable viscosity, i.e., preferably between about 300 and 10,000 centipoise or higher depending upon the coating method used, and include mixtures in which the monomers are partially polymerized to form the syrup, and monomeric mixtures which have been thickened with fillers such as silicas and the like.

The composite compositions of the present disclosure (i.e., comprising the polymeric microspheres and the acrylate monomers or acrylic syrup used to from the (meth)acrylate-based matrix) may be irradiated with activating UV radiation having a UVA maximum in the range of 280 to 425 nanometers to polymerize the monomer component(s). UV light sources can be of various types. Low light intensity sources, such as blacklights, generally provide intensities ranging from 0.1 or 0.5 mW/cm² (millwatts per square centimeter) to 10 mW/cm² (as measured in accordance with procedures approved by the United States National Institute of Standards and Technology as, for example, with a UVIMAP UM 365 L-S radiometer manufactured by Electronic Instrumentation & Technology, Inc., in Sterling, VA). High light intensity sources generally provide intensities greater than 10, 15, or 20 mW/cm² ranging up to 450 mW/cm² or greater. In some embodiments, high intensity light sources provide intensities up to 500, 600, 700, 800, 900 or 1000 mW/cm². UV light to polymerize the monomer component(s) can be provided by various light sources such as light emitting diodes (LEDs), blacklights, medium pressure mercury lamps, etc. or a combination thereof. The composite composition can also be polymerized with higher intensity light sources as available from Fusion UV Systems Inc., Gaithersburg, MD. The UV exposure time for polymerization and curing can vary depending on the intensity of the light source(s) used. For example, complete curing with a low intensity light course can be accomplished with an exposure time ranging from about 30 to 300 seconds; whereas complete curing with a high intensity light source can be accomplished with shorter exposure time ranging from about 5 to 20 seconds. Partial curing with a high intensity light source can typically be accomplished with exposure times ranging from about 2 seconds to about 5 or 10 seconds.

Preferably, the syrups of the invention are formed by partial polymerization of the monomers by free radical initiators which are known in the art and can be activated by thermal energy or radiation such as ultraviolet light. In some instances, it may be preferred to add additional monomer to the syrup, as well as further photoinitiator and other additives. An effective amount of at least one free radical initiator is added to the acrylate monomers or syrup comprising the polymeric microspheres. The mixture is then coated onto a substrate such as a transparent polyester film, which may optionally be coated with a release coating, and exposed to ultraviolet radiation in a nitrogen rich atmosphere to form a pressure sensitive adhesive. Alternatively, oxygen can be excluded by overlaying the coated adhesive with a second release coated polyester film. Preferably the ultraviolet radiation is provided by ultraviolet lamps having a majority of their emission spectra between about 280 and 400 nm (nanometer) with a peak at about 350 nm and an intensity less than about 20 milliWatt/cm². Subsequent exposure of the adhesive to a second source of energy can be used to cross-link or further cure the adhesive. Such sources of energy include heat, electron beam, gamma radiation, and high intensity ultraviolet lamps, such as mercury are lamps.

The adhesives of the present disclosure can also be prepared by bulk polymerization methods in which the adhesive composition comprising the monomers for the (meth)acrylate-based matrix, the polymeric microspheres, the cross-linking agent, the free radical initiator, and optional additional components described below is coated onto a flat substrate such as a polymeric film and exposed to an energy source, such as a UV radiation source, in a low oxygen atmosphere, i.e., less than 1000 parts per million (ppm), and preferably less than 500 ppm, until the polymerization is substantially complete, i.e., residual monomers are less than 10%, and preferably less than 5%.

Alternatively, a sufficiently oxygen free atmosphere can be provided by enclosing the polymerizable composite composition with, for example, a polymeric film. In one embodiment, the film can be overlaid on top of the coated adhesive composition before polymerization. In another embodiment, the adhesive composition is placed in pouches, which can be optionally sealed, and then exposed to energy, such as heat or ultraviolet radiation to crosslink the adhesive. The adhesive can then either be dispensed from the pouches for use, or the pouches can be fed to a hot melt coater and coated onto a substrate to make tapes or other types of adhesive coated substrates. In the latter case, the pouch material should be hot melt coatable with the adhesive in the pouch, and the pouch material does not deleteriously affect the desired end properties of the adhesive.

The pressure sensitive adhesive may comprise additional components to impact the performance and/or properties of the composition. Such additives include plasticizers, tackifiers, antistatic agents, colorants, antioxidants, pigments, dyes, fungicides, bactericides, organic and/or inorganic filler particles, and the like. Use of such additives is well known to those of ordinary skill in the art. In one embodiment, the additives are present at amounts such that the solids in the curable pressure sensitive adhesive composition (or the cured adhesive) comprise at least 65 wt % of the (meth)acrylate-based matrix. Therefore, the total amount of additives should be less than 35, 30, 25, 20, 10, 5, or even 1 wt % of the solids. Certain additives may be of lower weight percent, e.g., a pigment may be added at less than 0.05% or even less than 0.005% by weight solids. In some embodiments, such as the instance of inorganic fillers, large amounts of the inorganic fillers may be used (for example greater than 60, 70, 80 or even 95 wt % solids).

Exemplary tackifier include: CS-resins, terpene phenol resins, (poly)terpenes and rosin esters, hydrogenated hydrocarbons, and non-hydrogenated hydrocarbon resins. When used, the tackifiers may be added at a level of at least 5, 8, 10, or even 12 parts; and at most 15, 20, 25, or even 30 parts per 100 parts versus the weight of all of the (meth)acrylate-based matrix.

In one embodiment, the pressure sensitive adhesive disclosed herein is not a foam, meaning that the (meth)acrylate-based matrix comprises less than 5% by volume of voids, where the voids may be obtained by cells formed by gas, or due to the incorporation of hollow fillers, such as hollow polymeric particles, hollow glass microspheres or hollow ceramic microspheres.

The composite pressure sensitive adhesives disclosed herein may advantageously be used to prepare a wide range of adhesive tapes and articles. Many of these tapes and articles contain backings or release liners used to support the layer of adhesive. As used herein a backing is a permanent support intended for final use of the adhesive article. A liner, on the other hand, is a temporary support that is not intended for final use of the adhesive article and is used during the manufacture or storage to support and/or protect the adhesive article. A liner is removed from the adhesive article prior to final use. To facilitate easy removal from the adhesive layer, the liner is typically coated with a release coating comprising a release agent. Such release agents are known in the art and are described, for example in “Handbook of Pressure Sensitive Adhesive Technology,” D. Satas, editor, Van Nostrand Reinhold, New York, N.Y, 1989, pp. 585-600. In one embodiment, the release agent migrate to the surface (on the liner or release coating) to provide the appropriate release properties. Examples of release agents include carbamates, silicones and fluorocarbons. Illustrative examples of surface applied topical) release agents include polyvinyl carbamates such as disclosed in U.S. Pat. No. 2,532,011 (Dahlquist et al.), reactive silicones, fluorochemical polymers, epoxysilicones such as are disclosed in U.S. Pat. Nos. 4,313,988 (Bang et al.) and 4,482,687 (Kessel et al.), polyorganosiloxane-polyurea block copolymers such as are disclosed in EP Pat. No. 0250248 B1 (Leir et al.), etc.

In one embodiment, the adhesive article is a double-sided tape, featuring adhesive on opposite sides of a backing layer. The adhesives on the two sides may be the same or different. The backing layer may be a film, a non-woven web, paper, or a foam as further described below. The double-sided tape may comprise one or two release liners protecting the adhesive surface not in contact with the backing layer. In one embodiment, the adhesive layer is disposed between two release liners, which may be the same or different. In another embodiment, the adhesive layer is disposed on a backing and the opposing side of the backing comprises a release agent. The adhesive article is wound upon itself such that the exposed surface of the adhesive layer (opposite the backing) contacts the release-coated backing forming, for example, a roll of tape. In yet another embodiment, the adhesive is disposed between a backing and release liner. In some embodiments, the adhesive tapes and articles do not contain a backing and therefore are free standing adhesive layers. Transfer adhesive tapes are an example of such an adhesive article. Transfer adhesives tapes, also called transfer tapes, have an adhesive layer delivered on one or more release liners. The adhesive layer has no backing within it so once delivered to the target substrate and the liner is removed, there is only adhesive. Some transfer tapes are multi-layer transfer tapes with at least two adhesive layers that may be the same or different. Transfer tapes are widely used in the printing and paper making industries for making flying splices, as well as being used for a variety of bonding, mounting, and matting applications both by industry and by consumers.

In one embodiment, the pressure sensitive adhesive compositions may be easily coated upon a carrier film to produce adhesive coated sheet materials cured via ultraviolet radiation. Coating techniques known in the art may be used such as spray coating, flood coating, knife coating, Meyer bar coating, gravure coating, and double roll coating. The coating thickness will vary depending upon various factors such as, for example, the particular application or the coating formulation. Coating thicknesses of at least 10, 20, 25, 30, 40, 50, 60, 75, or even 100 μm are contemplated.

The carrier film may be a flexible or inflexible backing material, or a release liner. Exemplary materials useful as the carrier film for the adhesive articles of the disclosure include, but are not limited to, polyolefins such as polyethylene, polypropylene (including isotactic polypropylene and high impact polypropylene), polystyrene, polyester, including poly(ethylene terephthalate), polyvinyl chloride, poly(butylene terephthalate), poly(caprolactam), polyvinyl alcohol, polyurethane, poly(vinylidene fluoride), cellulose and cellulose derivatives, such as cellulose acetate and cellophane, and wovens and nonwovens. Commercially available carrier film include kraft paper (available from Monadnock Paper, Inc.); spun-bond poly(ethylene) and poly(propylene), such as those available under the trade designations “TYVEK” and “TYPAR” (available from The Chemours Co.); and porous films obtained from poly(ethylene) and poly(propylene), such as those available under the trade designations “TESLIN” (available from PPG Industries, Inc.), and “CELLGUARD” (available from Hoechst-Celanese). The carrier film delivers the pressure sensitive adhesive of the present disclosure to the desired substrate. The carrier film may comprise on the surface opposite the pressure sensitive adhesive, a pigment, indicia, text, design, etc., which is then fixedly attached to the surface of the substrate or the carrier film may be free of such pigments and/or markings.

The thickness of the pressure sensitive adhesive layer is typically at least 10, 15, 20, or even 25 microns (1 mil) and at most 50, 60, 70, 80, 90, or even 100 microns (4 mil) thickness. In some embodiments, the thickness of the pressure sensitive adhesive layer is no thicker than 100, 150, or even or even 200 microns and at most 300, 400 or even 500 microns (20 mils). The pressure sensitive adhesive can be coated in single or multiple layers. Due to the penetration depth of ultraviolet light, the thickness of the adhesive layer is generally limited to less than 1000, 800, 600, 400, 200, 100, 90, 80, or even 70 micrometers (gm). If a thicker adhesive is desired, additional adhesive layers can be added atop one another, generally with the presence of a backing layer therebetween (similar to the construction of a double-sided tape). The thickness of the pressure sensitive adhesive layer should be at least as thick, preferably thicker than the average particle diameter of the polymeric microspheres contained therein.

In one embodiment, the pressure sensitive adhesive of the present disclosure comprises at least 0.5, 1, 2, 4, or even 5 grams of the plurality of polymeric microspheres per 100 grams of the (meth)acrylate-based matrix. In one embodiment, the pressure sensitive adhesive composition comprises at most 10, 15, 20, or even 25 grams of the plurality of polymeric microspheres per 100 grams of the (meth)acrylate-based matrix.

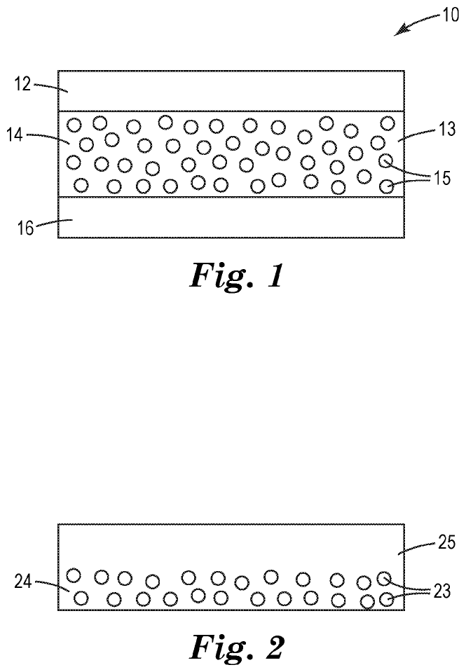

Typically, the polymeric microspheres are homogeneously dispersed throughout the (meth)acrylate-based matrix in layer of the pressure sensitive adhesive as shown in FIG. 1. FIG. 1 depicts a multilayered adhesive article comprising optional first substrate 12, and second substrate 16, which may be independently an adherend, a liner, or a backing. Sandwiched therebetween is composite adhesive layer 14 comprising a plurality of polymeric microspheres 13 dispersed in (meth)acrylate-based matrix 15. Alternatively, the polymeric microspheres may be concentrated in one or more regions of a layer of the pressure sensitive adhesive. For example, as shown in FIG. 2, the plurality of polymeric microspheres 23 in (meth)acrylate-based matrix 24 are concentrated near one major surface of composite adhesive layer 24.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength. Materials that have been found to function well as pressure sensitive adhesives are polymers designed and formulated to exhibit the requisite viscoelastic properties resulting in a desired balance of tack, peel adhesion, and shear holding power.

The (meth)acrylate-based matrix, which is the other component of the adhesive composition, plays a role of bonding between two adherends and may be tacky at ordinary temperature, or may not be initially tacky and adhesion builds over time.

In one embodiment, the pressure sensitive adhesive composition has a viscoelastic window as defined by E.P. Chang, J. Adhesion, vol. 34, pp. 189-200 (1991) such that the dynamic mechanical properties of the pressure sensitive adhesive composition as measured by well-known techniques fall within the following ranges measured at 25° C.:

G′ measured at an angular frequency of 0.01 rad/s is greater than 1×103 Pa;
G′ measured at an angular frequency of 100 rad/s is less than 1×106 Pa;
G″ measured at an angular frequency of 0.01 rad/s is greater than 1×103 Pa; and
G″ measured at an angular frequency of 100 rad/s is less than 1×106 Pa.

In one embodiment, the pressure sensitive adhesives according to the present disclosure not only have good adhesion to substrates having a high surface energy, but also demonstrate good adhesion to low surface energy substrates. In one embodiment, the pressure sensitive adhesive of the present disclosure has a peel value greater than 120, 140, or even 150 oz/in when tested according to ASTM D 3330/D3330M on a stainless steel after a heat dwell at 70° C. for 4 hours having a thickness of 2 mils. In one embodiment, the pressure sensitive adhesive of the present disclosure has a peel value greater than 240, 260, 280, 300, 320, or even 340 oz/in when tested according to ASTM D 3330/D3330M on a stainless steel after a heat dwell at 70° C. for 4 hours having a thickness of 5 mils. In one embodiment, the pressure sensitive adhesive of the present disclosure, has a peel value greater than 30, 35, 40, 45, or even 50 oz/in when tested according to ASTM D 3330/D3330M or FINAT test method No. 2 on a polypropylene after a heat dwell at 70° C. for 4 hours and having a thickness of 2 mils.

In one embodiment, the composite adhesive articles of the present disclosure can adhere to the traditional high energy substrates and show improved adherence to low energy substrate. A low surface energy surface is defined herein as a surface that exhibits low polarity and a critical surface tension less than about 50, 45, 43, 40, or even 30 mN/m (milliNewtons/meter). The surface tension may be measured as described by Owens et al. in the Journal of Applied Polymer Science, v. 13 p. 1741-1747 (1969). Exemplary substrates include: low density polyethylene (31 mN/m), polypropylene (28 mN/m), polystyrene (43 mN/m), polyvinyl chloride (39 mN/m), polyvinyl acetate, polyester, poly(meth)acrylates, such as polymethyl methacrylate (39 mN/m), and combinations thereof. Values taken from Owens et al. above Houwinck et al., in Adhesion and Adhesives, Elsevier Science, Amsterdam (1965).

In one embodiment, the pressure sensitive adhesives disclosed herein are optically clear. In one embodiment, the difference between the refractive index of the plurality of polymeric microspheres and the refractive index of the (meth)acrylate-based matrix is less than 0.2, 0.1, or even 0.05. The refractive index can be determined by using techniques known in the art. For example, the Becke Line Method wherein certified refractive test liquids are used along with a microscope to determine the refractive index of a material or the refractive index may be determined by using a refractometer and measuring the bend of a wavelength of 589 nm (sodium D line) at 25° C. in air.

In some embodiments of the present disclosure, it has been discovered that upon aging, the clarity of the pressure sensitive adhesive compositions according to the present disclosure do not degrade as much as those compositions not according to the present disclosure. Transmission is the amount of visible light that passes through the sample and reaches the detector. Light that is absorbed, scattered or reflected is not transmitted. In one embodiment, the composite compositions of the present disclosure transmit at least 80, 85, 90, or even 95% of the incident light. Of the light transmitted through the sample, haze refers to the percentage of light that deviates more than 2.5 degrees from the incident beam. Haze is a measure of the wide angle scattering and results in a reduction in contrast. In one embodiment, the constructions of the present disclosure have a haze of less than 10, 7, 5, 4, or even 2%. The adhesive composition has a haze value less than 4, or even 2% when aged at 65° C., 90% relative humidity for 500 hours. Clarity refers to transmitted light that deviates less than 2.5 degrees from the incident beam. Clarity is a measure of narrow angle scattering and relates to the resolution of detail of objects viewed through a sample. Clarity is a distance-dependent attribute, for example, decreasing as the distance between sample and object increases. In one embodiment, the sample is placed next to an illumination source and a sensor (comprising a center sensor and a ring sensor) is placed at a given distance from the illumination source. Clarity can be defined as

$$100 \% \cdot \frac{{I}_{C} - {I}_{R}}{{I}_{C} + {I}_{R}}$$

where I_{C} is the intensity at the center sensor and I_{R} is light intensity at the ring sensor. No clarity (or 0%) would be equal intensity at the center and ring sensor, and 100% clarity would be zero intensity at the ring sensor (i.e. no light diverted less than 2.5 degrees from the incident light beam). In one embodiment, the constructions of the present disclosure have a clarity of greater than 70, 75, 80, 85, or even 90%, but less than 95, 98, or even 99% using the method disclosed in the example section.

The pressure sensitive adhesive compositions described herein are suitable for use in the areas of electronics, appliances, automotive, and general industrial products. In some embodiments, the adhesive can be utilized in (e.g. illuminated) displays that can be incorporated into household appliances, automobiles (e.g., adhering to panels), computers (e.g. tablets), and various hand-held devices (e.g. phones).

In some embodiments, the pressure sensitive adhesive compositions described herein are suitable for bonding internal components or external components of illuminated display devices such as liquid crystal displays (“LCDs”) and light emitting diode (“LEDs”) displays such as cell phones (including Smart phones), wearable (e.g. wrist) devices, car navigation systems, global positioning systems, depth finders, computer monitors, notebook and tablet computer displays or bonding items (e.g., handles, display holders) to the exterior of electronic devices.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; or known to those skilled in the art unless otherwise stated or apparent.

These abbreviations are used in the following examples: ° C.=degree Celsius, g=gram, kg=kilograms, min=minutes, cm=centimeter, Hz=Hertz, J=Joule, mm=millimeter, mW=milliWatt, and wt=weight.

### Materials

| Designation | Description |
|---|---|
| EHA | 2-Ethylhexyl acrylate, available from BASF, Florham Park, NJ |
| IBOA | Isobornyl acrylate, available from San Esters, New York, NY |
| AA | Acrylic acid, available from BASF, Florham Park, NJ |
| HDDA | Hexanediol Diacrylate, available from Sartomer Americas, Exton, PA |
| IOA | Isooctyl acrylate, obtained from 3M Company, Cordova, IA |
| HEA | Hydroxyethyl acrylate, BASF, Florham Park, NJ |
| M1130 | Trimethyl cyclohexyl acrylate, obtained under the trade name “MIRAMER |
| | M1130” from Miwon Specialty Chemical Co., Ltd., Yongin-si, South Korea |
| Irg 651 | 2,2-Dimethoxy-1,2-diphenylethan-1-one, available under the trade |
| | designation “IRGACURE 651” from BASF Corporation, Vandalia, IL |
| PET-1 | A silicone release liner having a nominal thickness of 51 micrometers (0.002 |
| | inches), obtained from Dupont Teijin, Dupont Chemical Company, |
| | Wilmington, DE |
| PET-2 | RF12 N 2 mil, (50 μm) release coated PET film, obtained from SKC Haas, |
| | Seoul, Korea |
| PET-3 | RF22 N 2 mil, (50 μm) release coated PET film, obtained from SKC Haas, |
| | Seoul, Korea |
| PET-4 | Optically clear polyethylene terephthalate, obtained under the trade |
| | designation “SKYROL SH-81” from SKC Haas, Seoul, Korea |
| GLASS-1 | 1 mm thick optically clear glass, obtained under trade designation “EAGLE |
| | XG” from Corning Glass, Corning, NY |
| C12 Acrylates | Blend of C12 acrylates prepared as described in U.S. Pat. No. 9,102,774 |
| | (Clapper et al.) |
| STEPANOL | Ammonium lauryl sulfate, obtained under the trade designation “STEPANOL |
| AMV | AMV” from Stepan Company, Northfield, IL |
| HITENOL BC | Polyoxyethylene alkylphenyl ether ammonium sulfate, obtained under the |
| 1025 | trade designation “HITENOL BC 1025” from Montello, Inc., Tulsa, OK |
| VAZO 52 | 2-2′-Azobis(2,4-dimethylvaleronitrile), obtained from The Chemours |
| | Company, Wilmington, DE |
| 3-blade stirrer | 3-blade trailing edge stirrer, 3M Company, Saint Paul, MN |

### Preparatory Examples

Synthesis of Microsphere Additives Ml-M6 from pre-microsphere mixtures (A1-A9): A 1000 mL resin flask (4 in (10 cm) diameter) was charged with STEPANOL AMV, HITENOL BC 1025, and water in amounts as shown in Table 1 to provide an aqueous phase. In a separate flask, an oil phase was prepared by mixing monomers (C12 Acrylates, IBOA, t-OACM, M1130, HDDA) and VAZO 52 in amounts as shown in Table 1. After complete mixing with a polytetrafluoroethylene-coated magnetic stir bar, the oil phase was added to the aqueous phase all at once. An overhead stirrer equipped with a glass trailing edge stir rod was used to mix the phases at a rate as disclosed in Table 3. During the agitation, the multi-phase mixture was degassed by sparging with nitrogen for 30 minutes. After degassing, the mixture was heated to 60° C. The peak temperature during the exotherm typically reached as high as 75° C. The mixture was allowed to cool to 60° C. and was then maintained at that temperature for 8 hours. The mixture was cooled to room temperature. The solid microspheres were filtered in a Buchner funnel onto filter paper and were dried under vacuum. The microsphere particle sizes were determined and reported in Table 2.

TABLE 1
Pre-Microsphere Mixtures

| Pre- | Stabilizer Package (g) | | Monomers (g) | | | | | | |
|---|---|---|---|---|---|---|---|---|---|
| Microsphere | STEPANOL | HITENOL | C12 | | | | | Water | VAZO |
| Mixture | AMV | BC 1025 | Acrylate | IBOA | M1130 | HDDA | t-OACM | (g) | 52 (g) |
| A1 | 4.2 | 4.2 | 422 | 0 | 0 | 0.21 | 0 | 422 | 0.42 |
| A2 | 4.2 | 4.2 | 211 | 211 | 0 | 0.21 | 0 | 422 | 0.42 |
| A3 | 2.0 | 2.0 | 80 | 120 | 0 | 0.20 | 0 | 200 | 0.20 |
| A4 | 4.2 | 4.2 | 105.5 | 316.5 | 0 | 0.21 | 0 | 422 | 0.42 |
| A5 | 4.2 | 4.2 | 0 | 422 | 0 | 0.21 | 0 | 422 | 0.42 |
| A6 | 2.0 | 2.0 | 0 | 0 | 200 | 0.2 | 0 | 200 | 0.42 |
| A7 | 4.2 | 4.2 | 0 | 400 | 0 | 0.84 | 21 | 422 | 0.42 |
| A8 | 4.2 | 4.2 | 0 | 400 | 0 | 4.2 | 21 | 422 | 0.42 |
| A9 | 4.2 | 4.2 | 422 | 0 | 0 | 0.21 | 0 | 422 | 0.42 |

### Particle Size Measurements

Microsphere particle-size measurements were performed using a Horiba LA 910 particle size analyzer (Horiba, Ltd, Kyoto, Japan). The average particle size and standard deviation is are reported in Table 2.

TABLE 2
Microsphere Particle Sizes

| | | Average |
|---|---|---|
| | Pre- | Particle |
| | Microsphere | Diameter |
| Microsphere | Mixture | (μm) |
| M1 | A1 | 32 ± 13 |
| M2 | A2 | 31 ± 12 |
| M3 | A3 | 28 ± 10 |
| M4 | A4 | 32 ± 14 |
| M5 | A5 | 29 ± 10 |
| M6 | A6 | 26 ± 19 |
| M7 | A7 | 30 ± 11 |
| M8 | A8 | 73 ± 30 |
| M9 | A9 | 32 ± 13 |

### Preparation of Pre-adhesive Mixtures P1-P6

Pre-adhesive mixtures P1-P6 were prepared by mixing the respective reagents (EHA, AA, HDDA, Irg 651) in their respective amounts with the indicated microspheres as shown in Table 3.

TABLE 3
Pre-Adhesive Mixtures

| Pre- | | | | | | | | | | |
|---|---|---|---|---|---|---|---|---|---|---|
| Mixture | Component Mass (g) | | | | Microsphere Additive (g) | | | | | |
| adhesive | EHA | AA | HDDA | Irg 651 | M1 | M2 | M3 | M4 | M5 | M6 |
| P1 | 90 | 10 | 0.10 | 0.20 | 10 | 0 | 0 | 0 | 0 | 0 |
| P2 | 90 | 10 | 0.10 | 0.20 | 0 | 10 | 0 | 0 | 0 | 0 |
| P3 | 90 | 10 | 0.10 | 0.20 | 0 | 0 | 10 | 0 | 0 | 0 |
| P4 | 90 | 10 | 0.10 | 0.20 | 0 | 0 | 0 | 10 | 0 | 0 |
| P5 | 90 | 10 | 0.10 | 0.20 | 0 | 0 | 0 | 0 | 10 | 0 |
| P6 | 90 | 10 | 0.10 | 0.20 | 0 | 0 | 0 | 0 | 0 | 10 |

### Partially Polymerized Matrix Solution (51 & S2)

Partially polymerized matrix solution was prepared by charging a one-quart (1 liter) jar with the components in the amounts shown in Table 4, and stirred until the photoinitiator had dissolved and a homogeneous mixture was obtained. The mixture was degassed by introducing nitrogen gas into it through a tube inserted through an opening in the jar's cap and bubbling vigorously for at least 5 minutes. While stirring, the mixture was exposed to an array of LEDs having a peak emission wavelength of 365 nm at 0.3 mW/cm² until a pre-adhesive syrup having a viscosity deemed suitable for coating was formed. Following UV exposure, air was introduced into the jar.

TABLE 4
Partially Polymerized Matrix Solutions

| | Components (g) | | | | |
|---|---|---|---|---|---|
| Solution | EHA | AA | IBOA | HEA | Irg 651 |
| S1 | 315 | 35 | 0 | 0 | 0.12 |
| S2 | 55 | 0 | 25 | 20 | 0.2 |

### Preparation of Pre-Adhesive Mixture P7-P12

Pre-adhesive mixtures P7-P12 were prepared by mixing the components and microspheres in their respective amounts as indicated in Table 5.

TABLE 5
Pre-Adhesive Mixture

| Pre- | | | | | Microsphere | | |
|---|---|---|---|---|---|---|---|
| Mixture | Components (g) | | | | Additive (g) | | |
| adhesive | S1 | S2 | HDDA | Irg 651 | M7 | M8 | M9 |
| P7 | 80 | 0 | 0.08 | 0.16 | 0 | 0 | 0 |
| P8 | 0 | 50 | 0.05 | 0.1 | 0 | 0 | 0 |
| P9 | 0 | 50 | 0.05 | 0.1 | 2.5 | 0 | 0 |
| P10 | 0 | 50 | 0.05 | 0.1 | 0 | 2.5 | 0 |
| P11 | 0 | 50 | 0.05 | 0.1 | 0 | 5 | 0 |
| P12 | 0 | 50 | 0.05 | 0.1 | 0 | 0 | 2.5 |

### Examples

### Preparation of Example Adhesives E1-E4 and Comparative Example Adhesives CE1-CE3

The solutions presented in Tables 3 and 5 were coated using a roll coater onto the silicone coated surface of PET-1, and brought into intimate contact with a laminating face of PET-1. The resulting combination was exposed to a total UV-A energy of 1800 milliJoules/square centimeter using a plurality of UV-LEDs having a peak emission wavelength of 365 nanometers. The total UV-A energy was determined using a POWER PUCK II radiometer equipped with low power sensing head (available from EIT Incorporated, Sterling, VA) at a web speed of 4.6 meters/minute (15 feet/minute). The radiometer web speed and energy were then used to calculate the total exposure energy at the web speed using during curing of the acrylic composition. The examples are listed in Table 6.

### Preparation of Examples Adhesives E5-E7 and Comparative Example Adhesives CE4 & CE5

The solutions presented in Table 5 were knife coated onto PET-2 and brought into contact with laminating layer PET-3. The compositions were each cured by exposing the surface of PET3 to a total UVA energy of approximately 1824 milliJoules/square centimeter to form an adhesive disposed between two PET layers. The examples are listed in Table 6.

TABLE 6
Components of the Adhesives

| | Pre- |
|---|---|
| | adhesive |
| Sample | Mixture |
| E1 | P2 |
| E2 | P3 |
| E3 | P4 |
| E4 | P5 |
| E5 | P9 |
| E6 | P10 |
| E7 | P11 |
| CE1 | P1 |
| CE2 | P6 |
| CE3 | P7 |
| CE4 | P8 |
| CE5 | P12 |

### Rheology

Rheology was gathered using a rheometer (HR-3, TA Instruments, New Castle, DE) on some of the samples in Table 6. Before testing, the liner is removed exposing the adhesive, which has a thickness of 1-2 mm. Data was collected on cooling from 150° C. to -80° C. at a rate of 3° C./min using an oscillatory frequency of 1 Hz at strains (e<5%) in the linear viscoelastic regime. The glass transition (Tg) temperature was measured by the maxima in tan 6. The results are shown in Table 7, where G′ is the modulus.

TABLE 7

| | Rheology (3° C./min, 1 Hz, e < 5%) | | |
|---|---|---|---|
| | | G', 25° C. | G', 80° C. |
| Sample | T_{g} (C) | (kPa) | (kPa) |
| E1 | −24/6 | 135 | 36.5 |
| E2 | −14/21 | 212 | 46.3 |
| E3 | −17/52 | 1693 | 45.4 |
| E4 | −18/120 | 3207 | 1320 |
| E5 | −5 | 233 | 82 |
| CE1 | −3 | 124 | 38.5 |
| CE2 | −7/56 | 779 | 53.3 |
| CE3 | −7 | 125 | 38.4 |
| CE4 | −7 | 104 | 52 |

### Room Temperature Peel Adhesion

Stainless steel plate preparation—Grade 304 stainless steel (SS) plates, measuring 12.7 centimeters (5 inches) long by 5.1 centimeters (2 inches) wide by 0.13 centimeters (0.050 inches) thick, were prepared for testing by cleaning with series of solvents including methyl ethyl ketone and n-heptanes using a clean tissue (available under the trade designation KIMWIPE, available from Kimberly-Clark Corporation, Neenah, WI) three times with the last cleaning taking place immediately preceding sample preparation.

Polypropylene plate preparation—Polypropylene panes measuring 12.7 centimeters (5 inches) long by 5.1 centimeters (2 inches) wide by 0.13 centimeters (0.050 inches) thick, were prepared for testing by cleaning with isopropanol using a clean tissue (available under the trade designation KIMWIPE, available from Kimberly-Clark Corporation, Neenah, WI) three times with the last cleaning taking place immediately preceding sample preparation.

Adhesion testing was completed following a modified version of ASTM D 3330/D 3330M-04(2018). The adhesive samples were cut into strips measuring 1 inch (2.5 cm) wide and at least 8 inches (20 cm) long. Depending on the sample, the PET 1 or PET 2 liner was removed from one one side of the adhesive sample. The exposed adhesive was heat laminated to anodized aluminum backing. Removal of the second, opposing, PET release liner provides a multilayer article having a pressure sensitive adhesive layer, wherein one major surface of the pressure sensitive adhesive layer is exposed and the other opposing major surface is disposed on the anodized aluminum backing. The exposed adhesive side of the tape was adhered to the cleaned surface of either the stainless steel plate or the polypropylene plate described above. A 2 kilogram (4.5 pound) rubber roller was then rolled back and forth twice over the assembly. The assembly was equilibrated at 70° C. and 4 hrs prior to testing. The peel test (separating the adhesive on the aluminum backing from the stainless steel or polypropylene) was run at an angle of 180° on an Instron 3365, (Instron, Norwood, MA) with a 100 N load cell at a rate of 12 inches/min (30 cm/min).

Shown in Table 8 is the peel adhesion for a 5 mil (127 micron)-thick adhesive layer. Shown in Table 9 is the peel adhesion for a 2 mil (51 micron)-thick adhesive layer.

TABLE 8

| | Stainless Steel | | Polypropylene | |
|---|---|---|---|---|
| | Peel Force) | Peel Force | Peel Force | Peel Force |
| Example | (oz/in | (g/mm) | (oz/in) | (g/mm) |
| E1 | 345 ± 46 | 385.1 ± 51.3 | Not tested | |
| E2 | 331 ± 49 | 369.4 ± 54.7 | | |
| E3 | 276 ± 15 | 308.0 ± 16.7 | | |
| E4 | 241 ± 18 | 269.0 ± 20.1 | | |
| CE1 | 87 ± 4 | 97.1 ± 4.5 | | |
| CE2 | 237 ± 26 | 264.5 ± 29.0 | 51 ± 15 | 56.9 ± 16.7 |
| CE3 | 264 ± 30 | 294.7 ± 33.5 | 42 ± 8 | 46.9 ± 8.9 |

TABLE 9

| | Stainless Steel | | Polypropylene | |
|---|---|---|---|---|
| | Peel Force | Peel Force | Peel Force | Peel Force |
| Example | (oz/in) | (g/mm) | (oz/in) | (g/mm) |
| E3 | 153 ± 12 | 170.8 ± 13.4 | 49 ± 7 | 54.7 ± 7.8 |
| CE3 | 110 ± 10 | 122.8 ± 11.2 | 21 ± 2 | 23.4 ± 2.2 |

### Optical Durability Testing

Transmission/haze/clarity (‘THC’) measurements were performed using a BYK-Chemie (Wesel, Germany) Hazegard. The transfer tape was cut to approximately 5 cm width by 10 cm length. The RF12N liner (PET-2) was removed, and the adhesive with the second liner (PET-3) was laminated to an optically clear piece of 1 mm thick glass (Eagle Glass, Corning Glass, Corning, NY), GLASS-1. The second liner (PET-3) was then removed and a 2 mil (50 micron) thick layer of optically clear polyethylene terephthalate (PET, Skyrol SH-81 from SKC Haas, Seoul, Korea), PET-4 was laminated onto the assembly layer. The sample was placed in the Hazegard to measure THC through the PET-4/PSA/Glass-1 assembly. Samples were then aged in an oven chamber set to 65° C. and 90% relative humidity for ≥500 h or at 100° C. After samples were removed from the heat/humidity chamber and allowed to equilibrate in conditions of 50% relative humidity (RH) and 23° C. for at least 30 min, haze measurements were re-measured. Typically, samples acceptable for optically clear applications will retain haze values of less than about 2%, or more ideally less than 1% following these aging conditions. Results are reported in Table 10.

TABLE 10

| | | Conditions | | | | | | Appearance/# of Bubbles |
|---|---|---|---|---|---|---|---|---|
| | Thickness | Immediate | | | After aging | | | after |
| Sample | (micron) | T¹ | H² | C³ | T¹ | H² | C³ | 105° C., 18 h |
| CE4 | 115 | 91.3 | 2.28 | 99.1 | 91.3 | 1.41 | 99.3 | Clear/19 |
| E5 | 155 | 91.4 | 2.33 | 87.8 | 91.4 | 2.11 | 87.7 | Clear/5 |
| E6 | 150 | 91.0 | 4.15 | 85.0 | 91.6 | 2.01 | 85.9 | Hazy/0 |
| E7 | 180 | 90.9 | 6.42 | 74.9 | 91.4 | 3.73 | 75.4 | Clear/9 |
| CE5 | 200 | 89.1 | 8.19 | 73.9 | 89.1 | 7.55 | 74.6 | Very hazy/0 |

¹Transmittance,
²Haze,
³Clarity

Foreseeable modifications and alterations of this invention will be apparent to those skilled in the art without departing from the scope and spirit of this invention. This invention should not be restricted to the embodiments that are set forth in this application for illustrative purposes.

1. A pressure sensitive adhesive composition comprising:
a plurality of polymeric microspheres dispersed within a (meth)acrylate-based matrix, wherein the polymeric microspheres are derived from 20-100 wt % of isobornyl acrylate; and
the (meth)acrylate-based matrix comprises an at least partially polymerized reaction product comprising a C₄ to C₂₀ (meth)acrylate ester monomer.

2. The adhesive composition of claim 1, wherein the plurality of polymeric microspheres have an average particle diameter of at least 1 micrometer.

3. The adhesive composition of claim 1, wherein the plurality of polymeric microspheres have an average particle diameter of at least 20 micrometers and at most 200 micrometers.

4. The adhesive composition of claim 1, wherein the adhesive composition is a layer having a first thickness and the plurality of polymeric particles have an average particle diameter which is less than the first thickness.

5. The adhesive composition of claim 1, wherein the plurality of polymeric microspheres are derived from 50-90 wt % of isobornyl (meth)acrylate.

6. The adhesive composition of claim 1, wherein the plurality of polymeric microspheres are derived from 75-100 wt % of isobornyl (meth)acrylate.

7. The adhesive composition of claim 1, wherein the difference between the refractive index of the plurality of polymeric microspheres and the refractive index of the (meth)acrylate-based matrix to be less than 0.2.

8. The adhesive composition of claim 1, wherein the adhesive composition comprises at least 0.5 and at most 25 grams of the plurality of polymeric microspheres per 100 grams of the (meth)acrylate-based matrix.

9. The adhesive composition of claim 1, wherein the C₄ to C₂₀ (meth)acrylate ester monomer is selected from at least one of: butyl acrylate, isooctyl acrylate, 2-ethylhexyl acrylate, and combinations thereof.

10. The adhesive composition of claim 1, wherein the at least partially polymerized reaction product comprises 50-99.5 wt % of the C₄ to C₂₀ (meth)acrylate ester monomer.

11. The adhesive composition of claim 1, wherein the at least partially polymerized reaction product further comprises a polar monomer, optionally, wherein the polar monomer is acrylic acid.

12. The adhesive composition of claim 11, wherein the at least partially polymerized reaction product comprises 0.5-50 wt % of the polar monomer.

13. The adhesive composition of claim 1, wherein the at least partially polymerized reaction product further comprises a crosslinking agent.

14. The adhesive composition of claim 13, wherein the at least partially polymerized reaction product comprises 0.01 to parts (solid/solid) of the crosslinking agent per 100 parts weight of the sum of all monomers in the at least partially polymerized reaction product.

15. The adhesive composition of claim 1, wherein the at least partially polymerized reaction product is substantially free of solvent.

16. The adhesive composition of claim 1, wherein the adhesive composition has a peel adhesion value greater than 120 oz/in when tested according to ASTM D 3330/D3330M on stainless steel after a heat dwell at 70° C. for 4 hours and greater than 40 oz/in when tested according to ASTM D 3330/D3330M on polypropylene after a heat dwell at 70° C. for 4 hours.

17. The adhesive composition of claim 1, wherein the adhesive composition has a haze value less than 4% when aged at 65° C., 90% relative humidity for 500 hours.

18. An adhesive article comprising the adhesive composition according to claim 1, disposed on a substrate.

19. (canceled)

20. A method of making an adhesive article comprising:
(a) providing a mixture comprising a C₄ to C₂₀ (meth)acrylate ester monomer;
(b) dispersing a plurality of polymeric microspheres in the mixture to form a dispersion and optionally wherein the mixture is partially polymerized; and
(c) curing the dispersion, optionally by ultraviolet radiation.

21. The adhesive composition of claim 1, wherein the plurality of polymeric microspheres have a glass transition temperature of at least −10° C.
